(19) United States
(12) Patent Application Publication
(10) Pub. No.: US 2004/0061967 A1
(43) Pub. Date: Apr. 1, 2004

(54) Disk drive bi-directional servo track write method and apparatus

(76) Inventors: Hae Jung Lee, Santa Clara, CA (US); Sang Lee, Pleasonton, CA (US); Keung Youn Cho, San Jose, CA (US)

Correspondence Address: Gregory Smith & Associates, Suite 317, 3900 Newpark Mall Road, Newark, CA, 94560, US

(21) Appl. No.: 10/256,579

(22) Filed: Sep. 26, 2002

(51) Int. Cl. G11B 21/02

(52) U.S. Cl. 360/75

(57) ABSTRACT

Today, the servo tracks are written successively in one of two directions. The inventors discovered that both servo track writing directions have problems. These problems increase in severity as the TPI increases. The discovered problems also increase in severity as the read-write head diminishes in size. The invention includes a method of writing the servo tracks of a rotating disk surface by writing the servo tracks from the Outside Position to essentially the Middle Position and by writing the servo tracks from the Inside Position to essentially the Middle Position. Writing the servo tracks with this method significantly decreases the erase band overhead. The invention includes program systems and apparatus implementing the method of servo track writing.

### TECHNICAL FIELD

This invention relates to reducing air flow induced turbulence around a read-write head accessing a rotating disk in a disk drive to improve the read-write head's reliability.

### BACKGROUND ART

Disk drives are an important data storage technology. Read-write heads are one of the crucial components of a disk drive, directly communicating with a rotating disk surface containing the data storage medium, organized as tracks on the disk surface. A disk drive operates by first positioning a read-write head over a designated track on the rotating disk surface. The positioning is achieved by sensing a strip on the rotating disk surface containing the track, often known as the servo track. The invention decreases the required size of the servo track. Before discussing the invention in detail, some background regarding disk drives will be provided.

FIG. 1A illustrates a typical prior art high capacity disk drive 10 including actuator arm 30 with voice coil 32, actuator axis 40, actuator arms 50-58 with head gimbal assembly 60 placed among the disks.

FIG. 1B illustrates a typical prior art, high capacity disk drive 10 with actuator 20 including actuator arm 30 with voice coil 32, actuator axis 40, actuator arms 50-56 and head gimbal assembly 60-66 with the disks removed.

Since the 1980's, high capacity disk drives 10 have used voice coil actuators 20-66 to position their read-write heads over specific tracks. The heads are mounted on head gimbal assemblies 60-66, which float a small distance off the disk drive surface when in operation. The air bearing referred to above is the flotation process. The air bearing is formed by the rotating disk surface 12, as illustrated in FIGS. 1A-1B, and slider head gimbal assembly 60, as illustrated in FIGS. 1A-2A.

Often there is one head per head slider for a given disk drive surface. There are usually multiple heads in a single disk drive, but for economic reasons, usually only one voice coil actuator.

Voice coil actuators are further composed of a fixed magnet actuator 20 interacting with a time varying electromagnetic field induced by voice coil 32 to provide a lever action via actuator axis 40. The lever action acts to move actuator arms 50-56 positioning head gimbal assemblies 60-66 over specific tracks with speed and accuracy. Actuators 30 are often considered to include voice coil 32, actuator axis 40, actuator arms 50-56 and head gimbal assemblies 60-66. An actuator 30 may have as few as one actuator arm 50. A single actuator arm 52 may connect with two head gimbal assemblies 62 and 64, each with at least one head slider.

Head gimbal assemblies 60-66 are typically made by rigidly attaching a slider 100 to a head suspension including a flexure providing electrical interconnection between the read-write head in the slider and the disk controller circuitry. The head suspension is the visible mechanical infrastructure of 60-66 in FIGS. 1A to 2A. Today, head suspension assemblies are made using stainless steal in their suspension and beams. The head suspension is a steel foil placed on a steel frame, coated to prevent rust. It is then coated with photosensitive material. The suspension and flexures are photographically imprinted on the photosensitive material, which is then developed. The developed photo-imprinted material is then subjected to chemical treatment to remove unwanted material, creating the raw suspension and flexure.

Actuator arms 50-56 are typically made of extruded aluminum, which is cut and machined.

FIG. 2A illustrates the relationship between the principal axis 110 of an actuator arm 50 containing head gimbal assembly 60, which in turn contains slider 100, and the radial vector 112 from the center of rotation of spindle hub 80 as found in the prior art.

FIG. 2B illustrates the screw angle 300 formed by the principal axis 110 with respect to the radial tangent 116 where the read-write head 100 communicates with the rotating disk surface as found in the prior art.

The actuator arm assembly 50-60-100, pivots about actuator axis 40, changing the angular relationship between the radial vector 112 and the actuator principal axis 110. Typically, an actuator arm assembly 50-60-100 will rotate through various angular relationships. The farthest inside position is often referred to as the Inside Position. The position where radial vector 112 approximately makes a right angle with 110 is often referred to as the Middle Position. The farthest out position where the read-write head 100 accesses disk surface 12 is often referred to as the Outside Position.

Note that in the following Figures and discussion, the direction of rotation will be counter-clockwise. This is done merely to simplify the discussion and is not meant to limit the scope of the claims. One of skill in the art will recognize that disk surfaces may rotate clockwise just as well as counter-clockwise.

The skew angle 300 at the Middle Position is essentially zero. The skew angle will be considered negative at the Inside Position and positive at the Outer Position.

FIG. 2C illustrates the writ bulb of a two-pole read-write head 200, as found in prior art longitudinal recording of rotating disk surface 12.

Disk surfaces are prepared for formatting by first having all the servo tracks written. A servo track is a prerecorded reference track on a disk surface 12, used to determine when a read-write head is on or off the track. This is crucial when communicating data to the data track located essentially within the servo track.

The servo track radial width includes an erase band, which is an overhead component to the servo track. The erase band is essentially wasted disk surface. The erase band is caused by two separate mechanisms, one of which appears to be physically inherent in the magnetic recording scheme, and the other, the inventors discovered to be caused by the method of writing the servo tracks.

The first erase band mechanism is based upon a natural magnetic fringe effect between both write poles as illustrated in a longitudinal recording scheme as illustrated in FIG. 2C. This magnetic fringe effect is related to all parts of head and disk magnetic write function design. These design parts include magnetic properties and the geometry of the write poles, the number of coil turns, disk magnetic field coercivity Hc, and write head current, among other parameters. The difference of pole widths due to head process tolerances will also have additional effect to the ratio of erase band to effective magnetic write width of the servo track.

The progress in magnetic data recording density since 1957 to present has been achieved by a number of improvements, including the development of merged read-write heads, the scaling of the read-write head features, the recording medium and the distance between the read-write head and the recording medium. The development of merged read-write heads has allowed the industry to develop much more sensitive read heads, which further aided the memory density.

While the memory density within the disk drive industry has increased at an astonishing 60% annual growth rate for the last decade, there are physical limitations to the contemporary longitudinal approach to magnetic data recording. These memory density increases have required reducing the size of the magnetic particles making up the memory medium in order to maintain the signal to noise ratio of the memory system. The signal to noise ratio is essentially the number of magnetic particles per bit. As these particles decrease in size, there comes a point when the magnetic energy of the particle in its orientation will approximate its ambient thermal energy, at which point, the thermal energy of the bit's particles may disrupt the particles' magnetic orientation, making the memory bit unstable.

Simulations indicate that maintaining the 60% growth rate using the contemporary longitudinal approach of linearly scaling features will reach the thermal instability limit somewhere around 2004. Simulations based around using the bit cell decreased in track width more than bit length, indicate the thermal instability limit being reached about two years later.

Perpendicular recording techniques offer an alternative to longitudinal recording techniques and have the potential to support even greater memory densities.

FIG. 2D illustrates a read-write head 200 operating with rotating disk surface 12 in a perpendicular recording scheme as discussed in the prior art. In a perpendicular recording technique, the medium 12 is magnetized perpendicularly to the film plane, rather than in the film plane.

If a high permeability magnetic under-layer is placed under the perpendicularly magnetized thin film medium, then an image of the magnetic head pole is produced in the under-layer. This leads to the memory medium for bit cell effectively being in the gap under the recording head of FIG. 2D, which has a much stronger field than found in the fringing field experienced by a longitudinal medium by a longitudinal recording head of FIG. 2C. With the perpendicular recording techniques, it is possible to use mediums with greater magnetic anisotropy energy, which supports smaller magnetic particle sizes, leading to smaller bit cell sizes and even greater densities before the thermal instability limit is reached.

What is needed is a method minimizing the overhead for the servo track, thus improving the Tracks Per Inch (TPI) for both longitudinal recording and perpendicular recording schemes.

### SUMMARY OF THE INVENTION

The invention addresses at least the need discussed in the Background for minimizing servo track overhead.

Today, the servo tracks are written successively in one of two directions. These two directions are either to write servo tracks from the Outside Position to the Inside Position, or to write servo tracks from the Inside Position to the Outside Position.

The inventors discovered that both servo track writing directions have problems. These problems increase in severity as the Tracks Per Inch (TPI) increases. The discovered problems also increase in severity as the read-write head diminishes in size. The problems and the mechanism responsible for the problems are discussed in FIGS. 3A and 3B, hereafter.

The invention includes a method of writing the servo tracks of a rotating disk surface by writing the servo tracks from the Outside Position to essentially the Middle Position and by writing the servo tracks from the Inside Position to essentially the Middle Position. The essentially Middle Position has an essentially zero skew angle. The skew angles of the Inside Position and the Outside Position are not necessarily related to each other, one may be larger in absolute magnitude than the other.

The advantage of the invention is illustrated in FIGS. 4A and 4B hereafter. Writing the servo tracks with this method significantly decreases the erase band overhead. The inventors experimentally confirmed the advantages of the method using contemporary longitudinal recording techniques. The same advantages would result from using this method with perpendicular recording techniques.

The invention includes prerecorded disk surfaces, formatted disk surfaces, and disk drives including these disk surfaces, which are products of the method of writing the servo tracks. The invention also includes program systems and apparatus implementing the method of servo track writing.

These and other advantages of the present invention will become apparent upon reading the following detailed descriptions and studying the various figures of the drawings.

### BRIEF DESCRIPTION OF THE DRAWINGS

FIG. 1A illustrates a typical prior art high capacity disk drive 10 including actuator arm 30 with voice coil 32, actuator axis 40, actuator arms 50-58 with head gimbal assembly 60 placed among the disks;

FIG. 1B illustrates a typical prior art, high capacity disk drive 10 with actuator 20 including actuator arm 30 with voice coil 32, actuator axis 40, actuator arms 50-56 and head gimbal assembly 60-66 with the disks removed;

FIG. 2A illustrates the relationship between the principal axis 110 of an actuator arm 50 containing head gimbal assembly 60, which in turn contains slider 100, and the radial vector 112 from the center of rotation of spindle hub 80 as found in the prior art;

FIG. 2B illustrates the screw angle 300 formed by the principal axis 110 with respect to the radial tangent 116 where the read-write head 100 communicates with the rotating disk surface as found in the prior art;

FIG. 2C illustrates a read-write head 200 employing a two-pole read-write head as found in prior art longitudinal recording of rotating disk surface 12;

FIG. 2D illustrates a read-write head 200 operating with rotating disk surface 12 in a perpendicular recording scheme as discussed in the prior art;

FIG. 3A illustrates the problem the inventors discovered in servo track writing from Outside Position to Inside Position when writing tracks with negative skew angle 300 near the Inside Position track;

FIG. 3B illustrates the problem the inventors discovered in servo track writing from Inside Position to Outside Position when writing tracks with positive skew angle 300 near the Outside Position track;

FIG. 4A illustrates the result of using the invention's method to servo track write tracks with negative skew angle 300 from the Inside Position;

FIG. 4B illustrates the result of using the invention's method to servo track write tracks with positive skew angle 300 from the Outside Position;

FIG. 5A illustrates an apparatus 2000 implementing the method 1000 for writing servo tracks on a rotating disk surface; and

FIG. 5B illustrates the method 1000 for writing servo tracks of FIG. 5A.

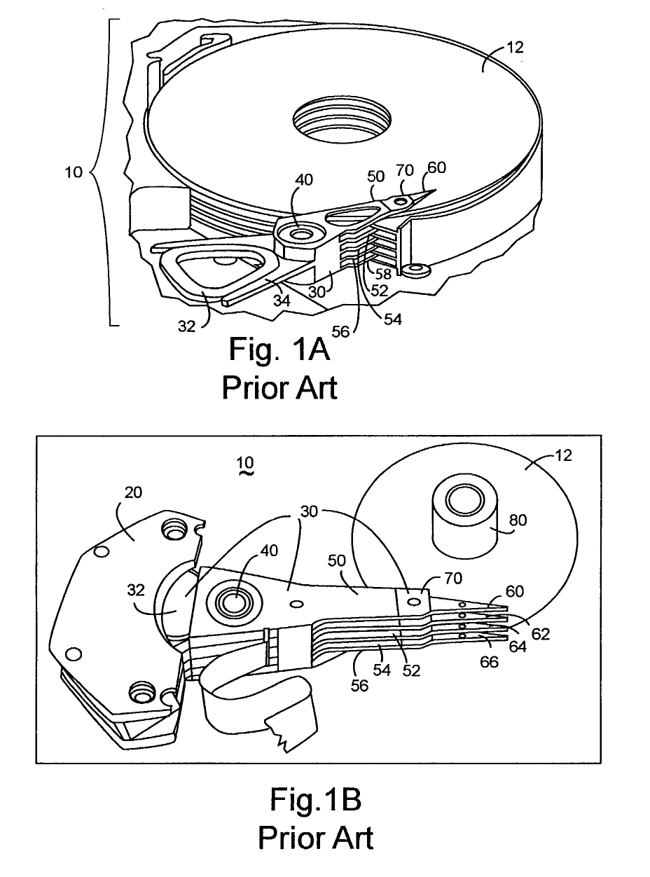

### DETAILED DESCRIPTION OF THE INVENTION

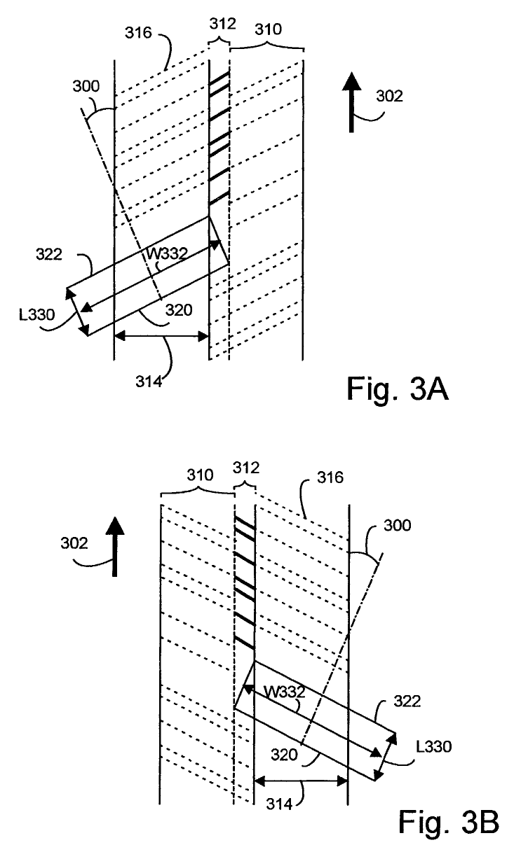

The inventors discovered that both servo track writing directions have problems. These problems increase in severity as the TPI increases. The discovered problems also increase in severity as the read-write head diminishes in size. The problems and the mechanism responsible for the problems are discussed in FIGS. 3A and 3B, hereafter.

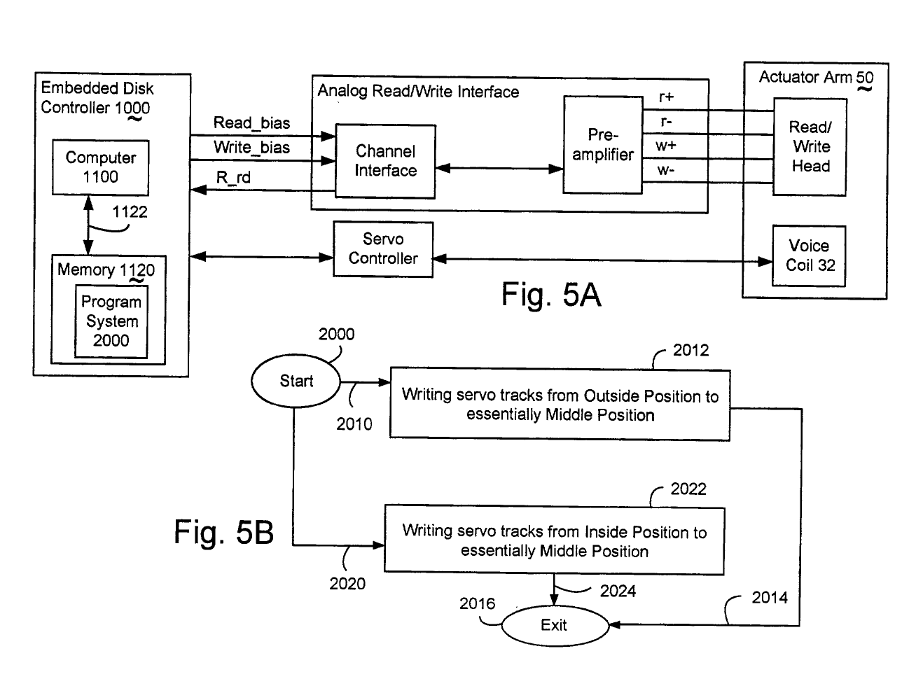

The invention includes a method of writing the servo tracks of a rotating disk surface by writing the servo tracks from the Outside Position to essentially the Middle Position and by writing the servo tracks from the Inside Position to essentially the Middle Position. The method is illustrated in FIG. 5B and an apparatus implementing the method is illustrated in FIG. 5A.

The essentially Middle Position has an essentially zero skew angle. The skew angles of the Inside Position and the Outside Position are not necessarily related to each other, one may be larger in absolute magnitude than the other.

FIG. 3A illustrates the problem the inventors discovered in servo track writing from Outside Position to Inside Position when writing tracks with negative skew angle 300 near the Inside Position track.

FIG. 3B illustrates the problem the inventors discovered in servo track writing from Inside Position to Outside Position when writing tracks with positive skew angle 300 near the Outside Position track.

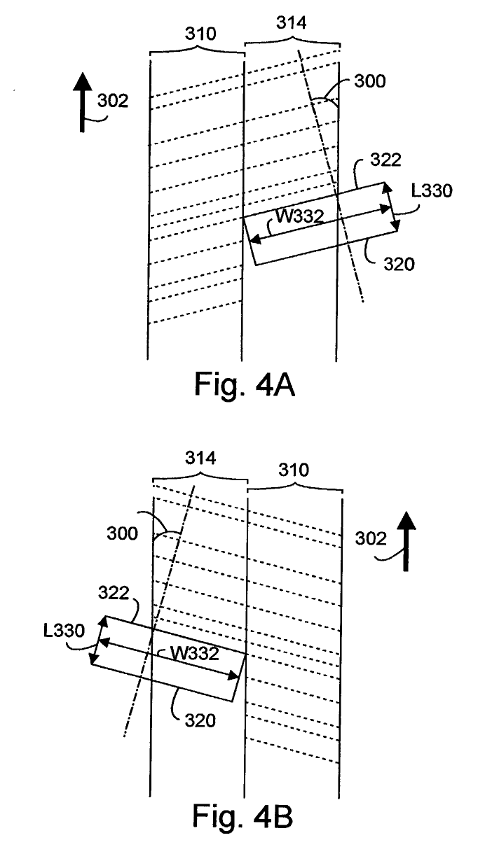

FIG. 4A illustrates the result of using the invention's method to servo track write tracks with negative skew angle 300 from the Inside Position.

FIG. 4B illustrates the result of using the invention's method to servo track write tracks with positive skew angle 300 from the Outside Position.

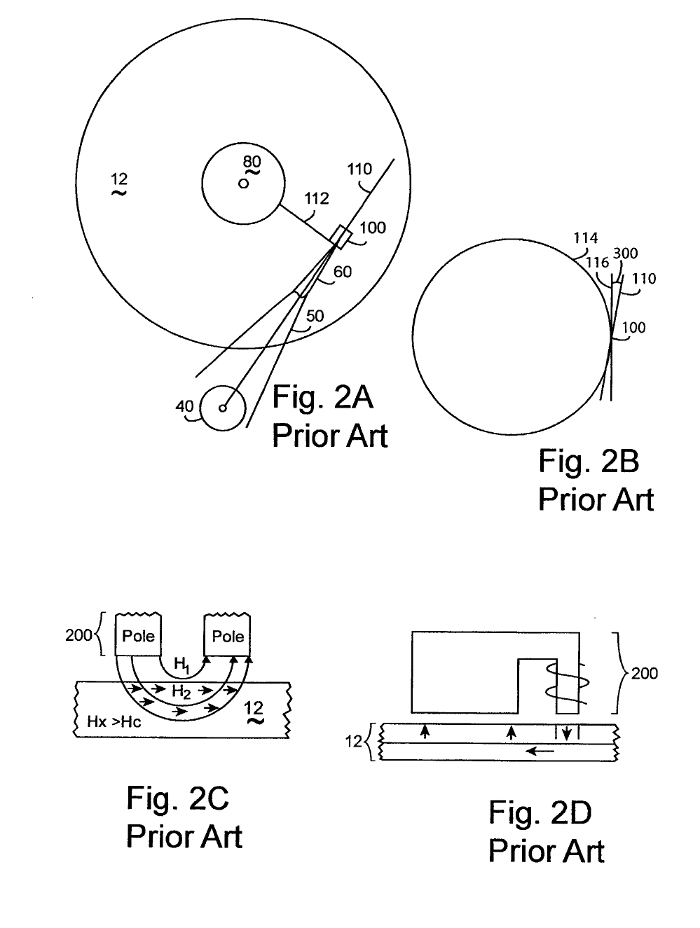

FIGS. 3A to 4B denote the previous track servo pattern by 310. The current track servo pattern is denoted 314. The write bulb length L 330 separates write bulb leading transition 320 and final transition 322. The write bulb width W 332 is perpendicular to principal axis 110, which forms skew angle 300 with the boundaries of the track servo patterns 310 and 314, which tend to be tangential as illustrated in FIG. 2B. The disk surface rotates in direction 302.

The inventors found a second mechanism contributing to the erase band caused by dimension of the write bulb. It was related to the write gap and skew angle of the hard disk drives. As track pitch decreases, the effects illustrated in FIGS. 3A and 3B play increasingly significant role in the areal overhead for both the data pattern area and the servo pattern area.

As the TPI in servo pattern increases, this effect will also increase. FIGS. 3A and 3B illustrate the mechanism and its effect during the writing of the servo pattern. While the final transition is being written, there is the same amount of transition at the leading edge of write bulb. If there is a non-zero skew angle 300, one edge side of the leading transition will over write the servo pattern of the previous track and creating the erase band 312 due to timing shift in the overwritten servo pattern.

In FIGS. 3A and 3B, shifted transition 312 of the erase band is created due to overwriting by the leading transition 320. This region 312 is the contribution the inventors discovered to the erase band. It is caused by writing all of the servo tracks in one direction, either from Outside Position to Inside Position, or from Inside Position to Outside Position. When servo tracks are written from Outside Position to Inside Position, the shifted transition 312 illustrated in FIG. 3A results. When servo tracks are written from Inside Position to Outside Position, the shifted transition 312 illustrated in FIG. 3B results. The shifted transition 312 has a size EB2 of L sin(a), where a is the skew angle 300.

As illustrated in FIGS. 3A and 3B, the EB2 exists only at one side of the write bulb based on the direction of track write and skew angle.

The method eliminates the second erase band mechanism by changing the direction of servo track writing. Writing the servo tracks with this method significantly decreases the erase band overhead. The inventors experimentally confirmed the advantages of the method using contemporary longitudinal recording techniques. The same advantages would result from using this method with perpendicular recording techniques.

Writing from the Outside Position to essentially the Middle Position is illustrated in FIG. 4A. At a positive skew angle, such as near the Outside Position, EB2 will not exist when servo track writing from Outside Position to essentially Middle Position, because the final transition 322 will be further out than the leading transition 320, which is illustrated in FIG. 4A.

Writing from the Inside Position to essentially the Middle Position is illustrated in FIG. 4B. At a negative skew angle, such as near the Inside Position, EB2 will not exist when servo track writing from Inside Position to essentially Middle Position, because the final transition 322 will further in than the leading transition 320, which is illustrated in FIG. 4B.

Note that near the Middle Position, the skew angle a is essentially zero, making EB2=L sin(a) essentially zero. As used herein, an essentially Middle Position is a position in which the skew angle is essentially zero. It may be preferred that the skew angle is within one degree of zero. It may be further preferred that the skew angle is within a fraction of a degree of zero, wherein preferable fractions may include thirty seconds, fifteen seconds, seven seconds, each of zero.

FIG. 5A illustrates an apparatus 1000 implementing the method 2000 for writing servo tracks on a rotating disk surface.

Disk drive controller 1000 controls an analog read-write interface communicating resistivity found in the spin valve within read-write head. Disk drive controller 1000 concurrently controls the servo-controller driving voice coil 32, of the voice coil actuator, to position actuator arm 50 with read-write head to access a rotating magnetic disk surface 12 of the prior art.

Analog read-write interface frequently includes a channel interface communicating with a pre-amplifier. The channel interface receives commands, from embedded disk controller 100, setting at least the read_bias and write_bias.

Various disk drive analog read-write interfaces may employ either a read current bias or a read voltage bias. By way of example, the resistance of the read head is determined by measuring the voltage drop (V_rd) across the read differential signal pair (r+ and r−) based upon the read bias current setting read_bias, using Ohm's Law.

A computer 1100 as used herein will include, but is not limited to an instruction processor. The instruction processor includes at least one instruction processing element and at least one data processing element, each data processing element controlled by at least one instruction processing element.

FIG. 5B illustrates the method 2000 for writing servo tracks of FIG. 5A.

Operation 2112 performs writing the servo tracks from the Outside Position to essentially the Middle Position. Operation 2122 performs writing the servo tracks from the Inside Position to essentially the Middle Position.

FIG. 5B includes a flowchart of the method of the invention possessing arrows with reference numbers. These arrows signify of flow of control and sometimes data supporting implementations of the steps of the method. These implementations may include at least one program step, or program thread, executing upon a computer, inferential links in an inferential engine, state transitions in a finite state machine, and dominant learned responses within a neural network.

The operation of starting the flowchart of FIG. 5B refers to at least one of the following. Entering a subroutine in a macro instruction sequence in a computer. Entering into a deeper node of an inferential graph. Directing a state transition in a finite state machine, possibly while pushing a return state. And triggering a collection of neurons in a neural network. The operation of termination in the flowchart of FIG. 5B refers to at least one or more of the following. The completion of those operations, which may result in a subroutine return, traversal of a higher node in an inferential graph, popping of a previously stored state in a finite state machine, return to dormancy of the firing neurons of the neural network.

The preceding embodiments have been provided by way of example and are not meant to constrain the scope of the following claims.

1. A method of making a prerecorded disk surface with servo patterns for each of at least three tracks, including an inside position track, an outside position track and an essentially middle position track, from a rotating disk surface, comprising the steps of:
servo pattern writing from said outside position track to said essentially middle position track on said rotating disk surface; and
servo pattern writing from said inside position track to said essentially middle position track on said rotating disk surface;
wherein said essentially middle position track has an associated skew angle which is essentially zero.

2. The method of claim 1, wherein said associated skew angle is within one degree of zero.

3. The method of claim 2, wherein said associated skew angle is thirty seconds of zero.

4. The method of claim 3, wherein said associated skew angle is fifteen seconds of zero.

5. The method of claim 4, wherein said associated skew angle is seven seconds of zero.

6. Said prerecorded disk surface as a product of the process of claim 1.

7. A method of making a formatted disk surface, comprising the step of using said prerecorded disk surface of claim 6 to create a said formatted disk surface.

8. Said formatted disk surface as a product of the process of claim 7.

9. A method of making a disk drive, comprising the step of assembling said disk drive using said formatted disk surface of claim 8.

10. Said disk drive as a product of the process of claim 9.

11. A method of making a disk drive, comprising the step of assembling said disk drive using said prerecorded disk surface of claim 6.

12. Said disk drive as a product of the process of claim 11.

13. An apparatus for making said prerecorded disk surface of claim 1, comprising:
a computer controlling a track position of a read-write head and said read-write head communicating near said rotating disk surface to create said prerecorded disk surface;
wherein said computer is controlled by a program system comprised of program steps residing in a memory accessibly coupled to said computer; and
wherein said program steps implement the steps of the method of claim 1.

14. Said program system of claim 12.

15. An apparatus for making said prerecorded disk surface of claim 1, comprising:
means for servo pattern writing from said outside position track to said essentially middle position track on said rotating disk surface; and
means for servo pattern writing from said inside position track to said essentially middle position track on said rotating disk surface.

16. An apparatus for making a prerecorded disk surface with servo patterns for each of at least three tracks, including an inside position track, an outside position track and an essentially middle position track, from a rotating disk surface, comprising the steps of:
means for servo pattern writing from said outside position track to said essentially middle position track on said rotating disk surface; and
means for servo pattern writing from said inside position track to said essentially middle position track on said rotating disk surface;
wherein said essentially middle position track has an associated skew angle which is essentially zero.

17. The apparatus of claim 1, wherein said associated skew angle is within one degree of zero.

18. The apparatus of claim 17, wherein said associated skew angle is thirty seconds of zero.

19. The apparatus of claim 18, wherein said associated skew angle is fifteen seconds of zero.

20. The apparatus of claim 19, wherein said associated skew angle is seven seconds of zero.

21. The apparatus of claim 16, comprising:
a computer controlling a track position of a read-write head and said read-write head communicating near said rotating disk surface to create said prerecorded disk surface;
wherein said computer is controlled by a program system comprised of program steps residing in a memory accessibly coupled to said computer; and
wherein said program steps implement said means of claim 16.

22. An apparatus for making a prerecorded disk surface with servo patterns for each of at least three tracks, including an inside position track, an outside position track and an essentially middle position track, from a rotating disk surface, comprising:
a computer controlling a track position of a read-write head and said read-write head communicating near said rotating disk surface to create said prerecorded disk surface;
wherein said computer is controlled by a program system comprised of program steps residing in a memory accessibly coupled to said computer; and
wherein said program system is comprised of the program steps of:
servo pattern writing from said outside position track to said essentially middle position track on said rotating disk surface; and
servo pattern writing from said inside position track to said essentially middle position track on said rotating disk surface;
wherein said essentially middle position track has an associated skew angle which is essentially zero.

23. The apparatus of claim 22, wherein said associated skew angle is within one degree of zero.

24. The apparatus of claim 23, wherein said associated skew angle is thirty seconds of zero.

25. The apparatus of claim 24, wherein said associated skew angle is fifteen seconds of zero.

26. The apparatus of claim 25, wherein said associated skew angle is seven seconds of zero.
